(19) United States
(12) Patent Application Publication
(10) Pub. No.: US 2026/0105242 A1
(43) Pub. Date: Apr. 16, 2026

(54) GENERATING BLENDED TEXT OBJECTS THAT PRESERVE VISUAL TEXT OBJECT CHARACTERISTICS

(71) Applicant: Adobe Inc., San Jose, CA (US)

(72) Inventors: Vinod Kumar Gambhir, Noida (IN); Manoj Kumar Santubhai Jain, Noida (IN)

(21) Appl. No.: 18/916,070

(22) Filed: Oct. 15, 2024

(51) Int. Cl. G06F 40/109; G06F 40/117; G06T 11/20

(52) U.S. Cl. CPC G06F 40/109; G06F 40/117; G06T 11/23

(57) ABSTRACT

The present disclosure is directed toward systems, methods, and non-transitory computer readable media that generate a blended text object for visual text objects of a digital design document. In particular, the disclosed systems utilize a common character detection model to determine a instances of shared characters between visual text objects. The disclosed systems determine a first instance of a common character within a first visual text object and a second instance of the common character within the second visual text object. Furthermore, the disclosed systems generate a modified second visual text object by replacing the second instance of the common character within the second visual text object with an empty character space. In addition, the disclosed systems align the first visual text object and the modified second visual text object within the digital design document based on the first instance of the common character and the empty character space.

### BACKGROUND

Advancements in computing devices and digital content design systems have led to innovative developments in computer image design and design software. For example, certain digital content design applications enable the editing and manipulation of text-based content to generate a variety of visual designs. For example, the existing workflows of digital content design applications allow for arranging and associating text-based content within digital designs. However, despite these advances, existing image editing systems have a number of shortcomings with regard to flexibility, efficiency, and accuracy in generating digital design documents with stylized text objects.

### SUMMARY

One or more embodiments provide benefits and/or solve one or more of the foregoing or other problems in the art with systems, methods, and non-transitory computer readable storage media that generate blended text objects utilizing intelligent character sequencing, replacement and alignment models to preserve visual text object characteristics. In particular, the disclosed systems utilize a common character detection model and an object sequence generation model to determine instances of common characters between a set of visual text objects, order the text objects according to common characters shared between text objects, and align the visual text objects so that multiple text objects interconnect at shared instances of the common characters. For example, in some implementations, the disclosed systems identify a common character shared between visual text objects, replace an instance of the common character with an empty character space, and align the remaining instance of the common character with the empty character space. Furthermore, the disclosed systems retain the textual features of the visual text objects such as font, color, size, and orientation. In this manner, the disclosed systems can efficiently and flexibly generate a variety of different blended text objects that retain text object characteristics, such as word mazes (e.g., having words intersecting at different orientations at common characters), text objects built to share a single common character, and/or word collections aligned in a first orientation to spell another word in a second orientation.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a blended visual object generation system in accordance with one or more embodiments;

FIG. 2 illustrates an example overview of generating a blended text object from visual text objects in accordance with one or more embodiments;

FIG. 3 illustrates an example of utilizing a common character detection model to generate matched visual text objects in accordance with one or more embodiments;

FIG. 4 illustrates an example of utilizing an object sequence generation model to generate matched visual text objects in accordance with one or more embodiments;

FIGS. 5A-5B illustrate an example of creating a blended text object that shares one common character between multiple visual text objects by enlarging the common character and aligning the visual text objects with the enlarged character in accordance with one or more embodiments;

FIGS. 6A-C illustrate examples of creating a blended text object that aligns multiple visual text objects with a single visual text object based on multiple common characters in accordance with one or more embodiments;

FIGS. 7A-7B illustrate an example of creating a blended text object that aligns multiple visual text objects in a sequence in accordance with one or more embodiments;

FIG. 8 illustrates a diagram of an example architecture of the blended visual object generation system in accordance with one or more embodiments;

FIG. 9 illustrates a flowchart of a series of acts for extracting vector outlines from a vector image in accordance with one or more embodiments; and

FIG. 10 illustrates a block diagram of an example computing device in accordance with one or more embodiments.

### DETAILED DESCRIPTION

This disclosure describes one or more embodiments of a blended visual object generation system that generates blended text objects utilizing intelligent character sequencing, replacement, and alignment algorithms to preserve visual text object characteristics. The blended visual object generation system overcomes the inherent shortcomings of existing design systems, particularly their technical limitation with regard to flexibility, accuracy, and operational efficiency when aligning visual text objects while retaining text style features. For example, many existing design systems lack the ability to accurately retain text style features when aligning interconnected textual content. Although some existing design systems provide tools to align textual content, many of these existing design systems require multiple independent operations which include removing text style features, which can lead to inaccuracies in the alignment.

Differences in font styles and sizes, for example, affect the spacing and positioning between interconnected textual content. In cases such as collaborative projects or graphic design—where unchanging text style features are essential—these multiple independent operations can introduce errors, resulting in misaligned content that deviates from the intended design. To illustrate, when text style features are removed prior to aligning the textual content, many existing design systems fail to accurately restore the correct alignment when the text font styles are reapplied. Additionally, many existing design systems lose control over key typographic elements, such as kerning and font customization, resulting in imprecise layouts and a loss of design integrity.

Furthermore, some existing design systems are inflexible. The inflexibility of exiting design systems is due in part to their inability to preserve original text style features when aligning textual content. For example, some existing design systems fail to retain the visual characteristics of textual content, removing custom fonts or text style features. Due to this inflexibility, when generating interconnected textual content these existing design systems require the user device to reapply text style features and then realign the modified textual content. In workflows involving multiple design iterations this inflexibility is amplified, requiring the user device to repeatedly reapply text style features and reducing the ability of the system to maintain consistent designs across changes. Additionally, existing design systems that discard the text style features lack the flexibility to seamlessly integrate with other images or graphics, or in collaborative projects. In such cases, user devices must frequently adjust the text style features of the textual content to regain a visual appearance that matches the overall design for the project.

Relatedly, many existing design systems are operationally inefficient, often relying on multiple device interactions. For example, some existing design systems depend on a multiple interactions to align, manipulate, and modify the visual text objects to generate interconnected elements. In existing design systems, this inefficiency is compounded when user devices must perform repetitive interactions to adjust the alignment between visual text objects as text style features are updated. Relatedly, existing design systems that discard font and size information to align textual content introduce additional inefficiencies when reformatting the textual content to reapply the text style features. For example, these existing design systems require additional device interactions to recalculate character spacing, text alignment, text size, text orientation, and/or text customization, a process that can be cumbersome and operationally inefficient.

Embodiments of the blended visual object generation system overcome these disadvantages of existing design systems. For example, in one or more embodiments, the blended visual object generation system utilizes a common character detection mode and object sequence generation model to determine instances of common characters between a set of visual text objects and align the visual text objects so that multiple text objects interconnect at shared instances of the common characters while maintaining text style features. To interconnect the visual text objects, the blended visual object generation system identifies a common character shared between visual text objects, replaces an instance of the common character with an empty character space, and aligns the remaining instance of the common character with the empty character space. Furthermore, the blended visual object generation system retains the textual features of the visual text objects such as font, color, size, orientation, and customization. In response to a user interaction, the blended visual object generation system creates a blended text object that either shares one common character between multiple visual text objects by enlarging the common character and aligning the visual text objects with the enlarged character, aligns multiple visual text objects with a single visual text object based on multiple common characters, and/or aligns multiple visual text objects in a sequence.

More specifically, in one or more embodiments, the blended visual object generation system utilizes a common character detection model to determine instances of common characters within a set of visual objects. In some cases, the blended visual object generation system utilizes the common character detection model to determine matched visual text objects based on the common characters. In one or more embodiments, the blended visual object generation system determines the matched visual text objects by determining instances of one common character shared between multiple visual text objects. In some cases, the blended visual object generation system determines the matched visual text objects by determining multiple common characters within a single visual text object that correspond to additional visual text objects. In certain embodiments, the blended visual object generation system determines the matched visual text objects by determining multiple common characters between consecutive visual text objects.

In certain embodiments, the blended visual object generation system utilizes a sequence generation model to generate modified visual text objects. For example, the sequence generation model iteratively analyzes combinations of the matched visual text objects to generate an ordered object sequence. To illustrate, the blended visual object generation system determines adjacent pairs of visual text objects based on common characters shared between the pairs of visual text objects. Utilizing the ordered object sequence, the blended visual object generation system generates a modified visual text object by replacing instances of common characters in adjacent pairs with empty character spaces. In certain embodiments, the blended visual object generation system maintains the text style features of the visual text objects to generate the modified visual text objects.

In one or more embodiments, the blended visual object generation system generates a blended text object by aligning the modified visual text objects. For example, the blended visual object generation system aligns a modified visual text object to an adjacent visual text object (or adjacent modified visual text object) such that the modified visual text object intersects with the remaining instance of the common character at the empty character space. As mentioned, in some cases, the blended visual object generation system aligns the modified visual text objects while maintaining the text style features of the modified visual text objects. In some embodiments, the blended visual object generation system aligns the modified visual text objects based on the proportions of the remaining instance of the common character.

In response to a user interaction, the blended visual object generation system creates a blended text object as described above. In particular, in some cases, the blended visual object generation system generates a blended text object that shares one common character between multiple visual text objects by enlarging one instance of the common character and aligning modified visual text objects with the enlarged character. In some cases, the blended visual object generation system creates a blended text object by aligning multiple modified visual text objects with a single visual text object based on multiple common characters. In some cases, the blended visual object generation system creates a blended text object by aligning multiple visual text objects from the ordered object sequence such that the visual text objects intersect at the empty character spaces and the corresponding common characters.

As suggested above, embodiments of the blended visual object generation system provide a variety of advantages over existing design systems. For example, one or more embodiments of the blended visual object generation system improve accuracy by preserving the text style features of the visual text objects when aligning visual text objects. Unlike existing systems that rely on multiple independent operations to generate interconnected textual content, embodiments of the blended visual object generation system seamlessly integrate text style features when generating blended text objects. In collaborative projects or graphic design applications—where maintaining consistent text style features is crucial—embodiments of the blended visual object generation system reduce errors by aligning visual text objects based on their original spatial characteristics. For example, font styles, sizes, orientation, and customization are preserved during alignment, ensuring that spacing and positioning between interconnected visual text objects remain consistent (e.g., precisely accounting for the size of the empty character space). As a result, embodiments of the blended visual object generation system can alleviate the need to reapply or adjust text style features post-alignment, significantly improving accuracy. Additionally, in some cases, the blended visual object generation system retains full control over typographic elements such as kerning, ensuring precise layouts and preserving the overall design integrity.

Relatedly, the blended visual object generation system provides advantages in flexibility over existing design systems by preserving the original text style features when aligning visual text objects. Unlike existing systems, embodiments of the blended visual object generation system retain the visual characteristics of the visual text objects, preserving design integrity and flexibly integrating the blended text object into workflows without the need for extensive reformatting. As a result, when generating interconnected visual text objects, embodiments of the blended visual object generation system reduce the need to reapply text font styles or realign modified text. In workflows involving multiple design iterations, embodiments of the blended visual object generation system improve design consistency, maintaining uniformity within collaborative design environments. In these cases, the blended visual object generation system maintains the original text font styles, allowing for smooth integration into the overall design without requiring additional adjustments.

As mentioned, the blended visual object generation system is operationally efficient, providing an intuitive interface to interconnect visual text objects. For example, based on minimal user device interaction, the blended visual object generation system determines common characters shared between visual text objects, generates an ordered object sequence based on the common characters, generates modified visual text objects, and aligns the modified visual text objects. In some embodiments, the efficiency of the blended visual object generation system is further enhanced by reducing the need for repetitive adjustments by maintaining the text style features when updating the blended text objects. Moreover, by retaining the text style features, embodiments of the blended visual object generation system require minimal user device interactions, reducing overhead and providing faster real-time results.

Furthermore, unlike existing design systems that discard text style features, embodiments of the blended visual object generation system work directly with the visual text objects, reducing the need for multiple conversions between text style features and enabling efficient system processing. For example, the blended visual object generation system handles the visual and textual processing simultaneously, allowing the blended visual object generation system to efficiently manage both text matching and formatting without requiring separate steps or additional processing to restore the text style features.

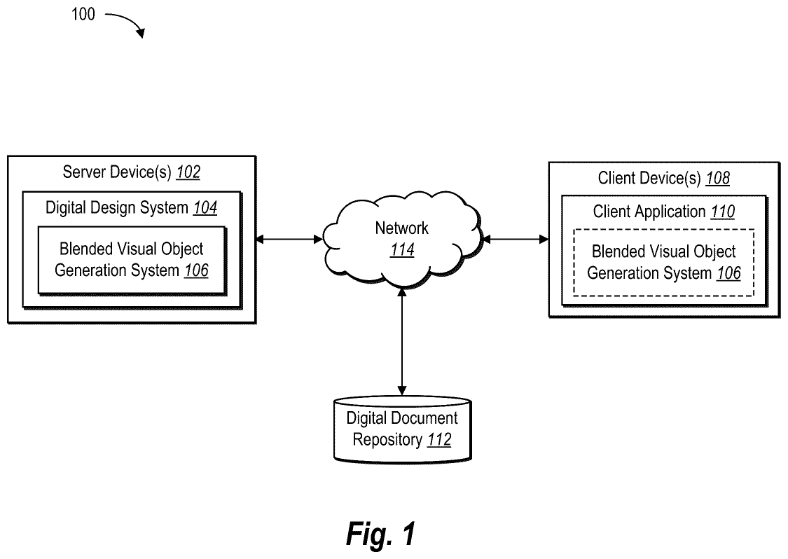

Additional detail regarding the blended visual object generation system will now be provided with reference to the figures. For example, FIG. 1 illustrates a schematic diagram of an exemplary system environment (“environment”) 100 in which a blended visual object generation system 106 operates. As illustrated in FIG. 1, the environment 100 includes server device(s) 102, a network 114, and client device(s) 108.

Although the environment 100 of FIG. 1 is depicted as having a particular number of components, the environment 100 is capable of having any number of additional or alternative components (e.g., any number of servers, client devices, or other components in communication with the blended visual object generation system 106 via the network 114. Similarly, although FIG. 1 illustrates a particular arrangement of the server device(s) 102, the network 114, and client device(s) 108, various additional arrangements are possible.

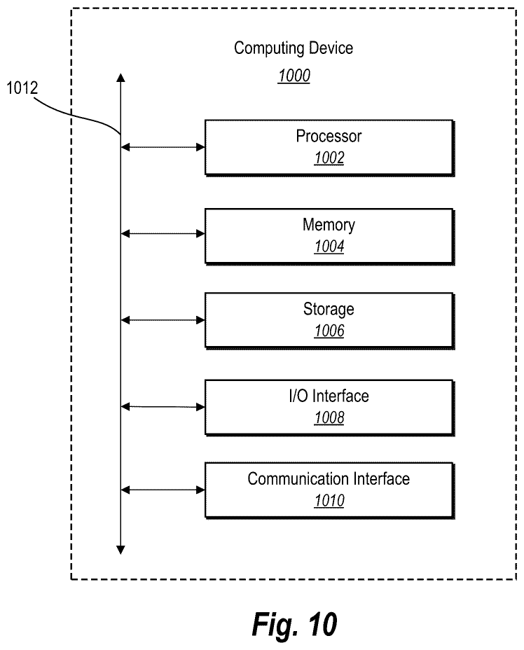

The server device(s) 102, the network 114, and client device(s) 108 are communicatively coupled with each other either directly or indirectly (e.g., through the network 114 discussed in greater detail below in relation to FIG. 10). Moreover, the server device(s) 102 and client device(s) 108 include one of a variety of computing devices (including one or more computing devices as discussed in greater detail with relation to FIG. 10).

As illustrated in FIG. 1, the environment 100 includes the server device(s) 102 and digital design system 104. The server device(s) 102 utilizes the digital design system 104 to generate, track, store, process, receive, and transmit electronic data including visual text objects and blended text objects. For example, the server device(s) 102 receives or monitors interactions across the client device(s) 108. In some embodiments, the server device(s) 102 transmits content to the client device(s) 108 to cause the client device(s) 108 to display content associated with generating blended text objects. For example, the server device(s) 102 presents visual text objects to client device(s) 108 and displays blended text objects on the client device(s) 108 with the blended text objects displayed corresponding to system need (e.g., provides visual text objects and blended text objects for display via the client application 110). The server device(s) 102 further access and utilize the digital document repository 112 to store and retrieve information such as stored digital documents, digital images, visual text objects, blended text objects, and/or other data.

Additionally, the server device(s) 102 includes all, or a portion of, the blended visual object generation system 106. For example, the blended visual object generation system 106 operates on the server device(s) 102 to access digital content (including images and visual text objects), determine digital content changes, and provide localization of content changes to the client device(s) 108. In one or more embodiments, via the server device(s) 102, the blended visual object generation system 106 generates and displays visual text objects and/or blended text objects based on the client device(s) 108 input. Example components of the blended visual object generation system 106 will be described below with regard to FIG. 10.

Furthermore, as shown in FIG. 1, the illustrated system includes the client device(s) 108. In some embodiments, the client device(s) 108 include, but are not limited to, mobile devices (e.g., smartphones, tablets), laptop computers, desktop computers, or another type of computing devices, including those explained below in reference to FIG. 10. Some embodiments of client device(s) 108 are operated by a user to perform a variety of functions via client application 110 such as the generation of blended text objects. The client device(s) 108 include one or more applications (e.g., the client application 110) that access, edit, modify, store, and/or provide, for display, digital image content. For example, in some embodiments, the client application 110 include a software application installed on the client device(s) 108. In other cases, however, the client application 110 include a web browser or other application that accesses a software application hosted on the server device(s) 102.

In one or more embodiments, the blended visual object generation system 106 is implemented in whole, or in part, by the individual elements of the environment 100. Indeed, as shown in FIG. 1, the blended visual object generation system 106 is implemented with regard to the server device(s) 102 and the client device(s) 108. In particular embodiments, the blended visual object generation system 106 on the client device(s) 108 comprises a web application, a native application installed on the client device(s) 108 (e.g., a mobile application, a desktop application, a plug-in application, etc.), or a cloud-based application where part of the functionality is performed by the server device(s) 102.

In additional or alternative embodiments, the blended visual object generation system 106 on the client device(s) 108 represents and/or provides the same or similar functionality as described herein in connection with the blended visual object generation system 106 on the server device(s) 102. In some embodiments, the blended visual object generation system 106 on the server device(s) 102 supports the blended visual object generation system 106 on the client device(s) 108.

In some embodiments, the blended visual object generation system 106 includes a web hosting application that allows the client device(s) 108 to interact with content and services hosted on the server device(s) 102. To illustrate, in one or more embodiments, the client device(s) 108 accesses a web page or computing application supported by the server device(s) 102. The client device(s) 108 provides input to the server device(s) 102 (e.g., selected visual text objects). In response, the blended visual object generation system 106 on the server device(s) 102 generates blended text objects. The server device(s) 102 then provides the blended text objects to the client device(s) 108.

In some embodiments, though not illustrated in FIG. 1, the environment 100 has a different arrangement of components and/or has a different number or set of components altogether. For example, in certain embodiments, the client device(s) 108 communicate directly with the server device(s) 102, bypassing the network 114. As another example, the environment 100 includes a third-party server comprising a content server and/or a data collection server.

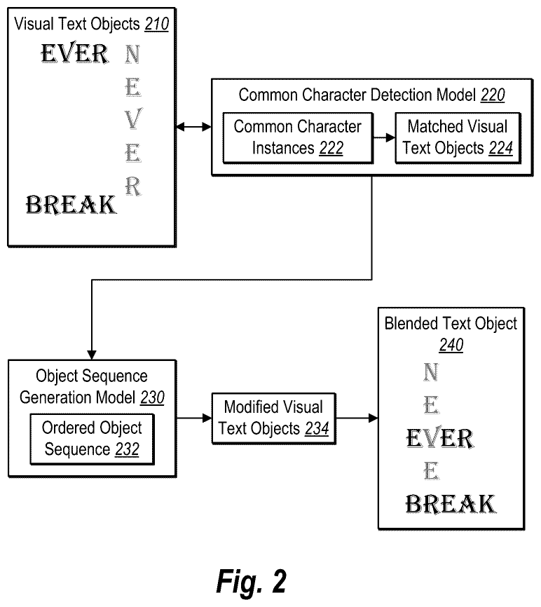

As previously mentioned, in one or more embodiments, the blended visual object generation system 106 aligns visual text objects based on instances of common characters to generate a blended text object. For instance, FIG. 2 illustrates an example overview of generating a blended text object from visual text objects in accordance with one or more embodiments. Additional detail regarding the various acts of FIG. 2 is provided thereafter with reference to subsequent figures.

As shown in FIG. 2, the blended visual object generation system 106 receives or extracts visual text objects 210. For example, the visual text objects 210 include or refer to graphical representations of textual content (e.g., within a digital design document). In some cases, the visual text objects 210 include graphical elements that are rendered within digital design software in a way that allows for precise manipulation within a visual composition. For example, visual text objects 210 maintain their text-based origin while functioning as graphical entities, enabling the visual text objects 210 to be resized, rotated, transformed, and aligned within a design application. To illustrate, the visual text objects 210 incorporate text style features such as font type, font weight, text size, text color, text orientation, and/or text customization, along with other visual attributes like kerning, tracking, and leading. In one or more embodiments, the blended visual object generation system 106 extracts a set of text style features for each visual text object of the visual text objects 210.

As further shown, the blended visual object generation system 106 utilizes a common character detection model 220 to determine matched visual text objects based on common character instances between the visual text objects 210. For example, a common character includes or refers to a specific character (e.g., letter, number, symbol, or textual element) that appears in more than one visual text object. To illustrate, if two visual text objects contain the words “design” and “damp,” the letter “d” would be considered a common character. In some cases, common characters share character codes, such as ASCII or Unicode, between them.

For example, the common character detection model 220 includes or refers to a computer implemented algorithm that analyzes visual text objects and identifies common characters shared between the visual text objects (e.g., common character instances 222). In some embodiments, the common character detection model 220 examines the textual content within each of the visual text objects 210 and determines where identical characters appear within the visual text objects 210 to identify the common characters (alternatively referred to as “shared characters”). In some embodiments, the common character detection model 220 utilizes the common character instances 222 to determine matched visual text objects 224. For example, the common character detection model 220 determines the matched visual text objects 224 as pairs of visual text objects from the visual text objects 210 that contain one or more common characters.

As further shown, the blended visual object generation system 106 generates modified visual text objects 234. In one or more embodiments, an object sequence generation model includes or refers to a computer-implemented algorithm that identifies, generates, or creates a sequence or arrangement of visual text objects. In particular, an object sequence generation model includes a model that identifies a sequence of visual text objects where adjacent text objects include common characters.

Thus, in some embodiments, the object sequence generation model 230 analyzes the matched visual text objects 224 to generate an ordered object sequence 232. In one or more embodiments, the ordered object sequence 232 includes or refers to an ordered sequence of visual text objects wherein each adjacent pair of visual text objects within the ordered object sequence 232 share a common character. For example, the blended visual object generation system 106 utilizes the ordered object sequence 232 to position the matched visual text objects 224 in a predetermined order. In this way, in some cases, the blended visual object generation system 106 controls the order in which the visual text objects 210 are processed or aligned, thereby generating a blended text object 240 where the visual text objects 210 overlap (e.g., intersect) in a visually consistent manner.

In one or more implementations, the blended visual object generation system 106 generates the modified visual text objects 234 by replacing instances of common characters within the visual text objects. In some cases, the blended visual object generation system 106 generates the modified visual text objects 234 by replacing instances of common characters within the visual text objects with empty character spaces (alternatively referred to as “character spaces”). In some cases, the blended visual object generation system 106 generates the modified visual text objects 234 by replacing instances of common characters within the visual text objects with modified common characters. As shown, the object sequence generation model 230 generates the modified visual text objects 234 based on the common character instances 222.

For example, based on the ordered object sequence 232, the blended visual object generation system 106 replaces an instance of each common character in the adjacent pairs of the ordered object sequence 232. In some cases, the blended visual object generation system 106 replaces an instance of each common character in the adjacent pairs of the ordered object sequence 232 with an empty character space. For example, as used by the blended visual object generation system 106, the empty character space includes or refers to a placeholder, allowing the visual text objects 210 to position the visual text objects 210 such that the visual text objects 210 intersect at the correct points. In some cases, the empty character space is generated with the same proportions (e.g., size, height, and/or width) as the replaced instance of the common character. In some cases, the empty character space is generated with the same proportions as the remaining instance of the common character. In this way, the blended visual object generation system 106 creates modified visual text objects 234 that retain the spacing of the visual text objects 210 without distorting the visual text objects 210.

In one or more embodiments, the blended visual object generation system 106 generates the blended text object 240 by aligning the modified visual text objects 234. For example, the blended visual object generation system 106 aligns the visual text objects 210 in the ordered object sequence 232 by aligning each adjacent pair of the visual text objects 210 based on the first instance (e.g., the remaining instance) of the common character and the empty character space. As shown in FIG. 2, the visual text objects 210 are aligned within the blended text object 240 such that the visual text objects 210 intersect at the precise location of the common characters (e.g., the “V” and the “R”). As shown, the blended visual object generation system 106 generates the blended text object 240 as a result of blending or interconnecting the visual text objects 210 within the ordered object sequence 232 into a single, integrated object.

Notably, the blended visual object generation system 106 maintains the text style features of the visual text objects 210 to generate the blended text object 240. For example, the blended visual object generation system 106 retains the original sets of text style features for the visual text objects 210 including features such as font type, font weight, text size, text color, spacing and/or text customization. For example, when aligning a first adjacent visual text object and a second adjacent visual text object that share a common character, the blended visual object generation system 106 aligns the first instance of the common character within a first visual text object and the empty character space of a second visual text object while maintaining the text style features of both the first visual text object and the second visual text object.

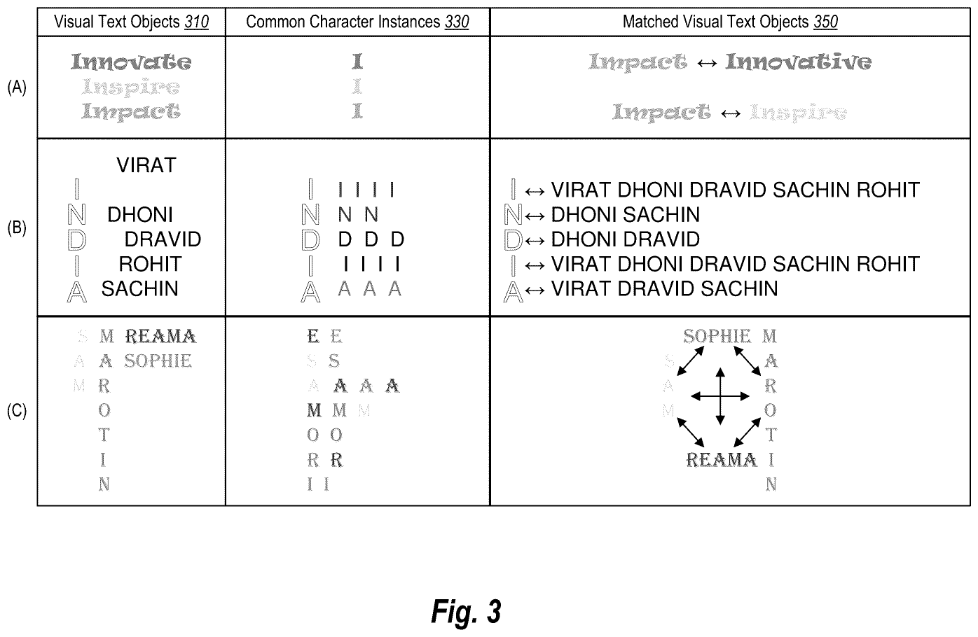

As mentioned, the blended visual object generation system 106 generates matched visual text objects from the visual text objects. FIG. 3 illustrates an example of utilizing a common character detection model to generate matched visual text objects in accordance with one or more embodiments.

As shown, the blended visual object generation system 106 receives or extracts visual text objects from a digital design document. As mentioned, in one or more embodiments, the blended visual object generation system 106 extracts the visual text objects 310 that include graphical representations of textual content including associated text style features. As shown, the visual text objects 310 incorporate the text style features to visually present the textual content using customized colors, font styles, size, configuration, and orientation. To illustrate, the blended visual object generation system 106 extracts text style features which incorporate the visual elements that influence how the visual text objects 310 appear in a digital design.

To illustrate, as shown in FIG. 3, the blended visual object generation system 106 extracts the visual text objects 310 in Section (A) including the words “Innovate,” “Inspire,” and “Impact” that share a common orientation and style, but utilize different font colors. Additionally, the blended visual object generation system 106 extracts the visual text objects 310 in Section (B) that include the vertical word “INDIA” in a first orientation, size, and font style in conjunction with the horizontal words “VIRAT,” “DHONI,” “DRAVID,” and “ROHIT,” and “SACHIN” in a second orientation, size, and font style. Furthermore, the blended visual object generation system 106 extracts the visual text objects 310 in Section (C) that include a vertical word “SAM,” a vertical word “MAROTIN,” a horizontal word “REAMA,” and a horizontal word “SOPHIE” that share a common font style and size but have different font colors.

In addition, the blended visual object generation system 106 utilizes the common character model to determine common character instances 330 of common characters shared between the visual text objects. For example, the common character model analyzes the textual content within each of the visual text objects 310 to identify common character instances 330 by extracting the textual content (e.g., characters) from the visual text objects 310. In some cases, once the characters are extracted, the common character model compares characters across the visual text objects 310 to identify where the same characters (i.e., common characters) appear within the visual text objects. In some cases, the common character model compares the character codes (e.g., ASCII or Unicode) to find character matches.

In some cases, the blended visual object generation system 106 prioritizes the selection of specific common characters to determine the common character instances 330. For example, as shown in FIG. 3, the common character model analyzes the common character instances 330 in Section (A) based on a shared common character between all of the visual text objects 310 to determine the common character instances 330 as the 3 instances of the letter “I.” In certain cases, the common character model analyzes the common character instances 330 in Section (A) based on the initial character or on the capital character of the visual text objects 310 to determine the common character instances 330 as the 3 instances of the letter “I.” To illustrate, the common character model determines that the visual text objects 310 contain common character instances 330 in Section (A) as 3 instances of the initial common character “I” shared between each of the visual text objects 310.

As also shown in Section (B), in certain cases, the common character model prioritizes selection of the common character instances 330 based on an orientation, user selection, or other feature (e.g., to generate matches between the horizontal objects of the visual text objects 310 with the letters of the vertical/selected visual text object “INDIA”). Furthermore, the common character model determines that the visual text objects 310 in Section (B) contain the common character instances 330 of characters shared with the vertical word “INDIA.” In particular, for Section (B), the common character model determines that the common character instances 330 are: 5 instances of the initial common character “I,” 3 instances of the common character “N,” 4 instances of the common character “D,” 4 instances of the additional common character “I,” and 4 instances of the common character “A.”

Moreover, the common character model determines that the visual text objects 310 in Section (C) contain the common character instances 330 of all shared characters for the visual text objects 310. In particular, for Section (C), the common character model determines that the common character instances 330 are: 2 instances of the initial common character “E,” 2 instances of the common character “S,” 4 instances of the common character “A,” 3 instances of the common character “M,” 2 instances of the additional common character “O,” 2 instances of the additional common character “R,” and 2 instances of the common character “I.”

As further shown in FIG. 3, the blended visual object generation system 106 utilizes the common character model to determine matched visual text objects 350 for the common character instances 330. For example, the common character model determines matches between the visual text objects 310 based on the common character instances 330. In some cases, based on two or more of the visual text objects 310 containing instances of the same character, the common character model determines the matched visual text objects 350.

In some embodiments, the blended visual object generation system 106 prioritizes specific combinations of the common character instances 330. For example, in Section (A), the blended visual object generation system 106 prioritizes matches based on a character shared between all of the visual text objects 310 (or, alternatively, an initial common character of the visual text objects 310). As shown, the blended visual object generation system 106 generates the matched visual text objects 350 of “impact” with “innovative” and “impact” with “inspire.”

As also shown, in Section (B) the blended visual object generation system 106 prioritizes selection of the common character instances 330 to generate matches based on an orientation (or other feature, such as user selection or word significance/importance). For example, the blended visual object generation system 106 generates matches between the visual text objects 310 based on the letters of the visual text object “INDIA” oriented in a first direction with letters of the visual text objects 310 oriented in a second direction (e.g., “VIRAT,” “DHONI,” “DRAVID,” “ROHIT,” and “SACHIN”).

In certain embodiments, the blended visual object generation system 106 identifies matches based on more than one common character between the visual text objects 310. For example, as shown in Section (C), the common character model determines matches between each of the visual text objects 310 (e.g., at least one common character shared between each of the visual text objects 310). Additionally, in some embodiments, the blended visual object generation system 106 determines multiple matches between two visual text objects (e.g., “REAMA” matches “MAROTIN” twice with the letter “A,” once with the letter “R,” and once with the letter “M”).

Although FIG. 3 illustrates finding all (or a significant portion) of common character instances across words, in some implementations, the blended visual object generation system 106 only identifies a small subset of common characters across words. For example, the iteratively identifies common characters and matching word pairs and then analyzes those word pairs iteratively to determine a sequence that produces a functional outcome (e.g., without analyzing all possible combinations, and stopping when a functional solution is identified). Additional detail regarding identifying common characters and generating a visual text object sequence is provided below.

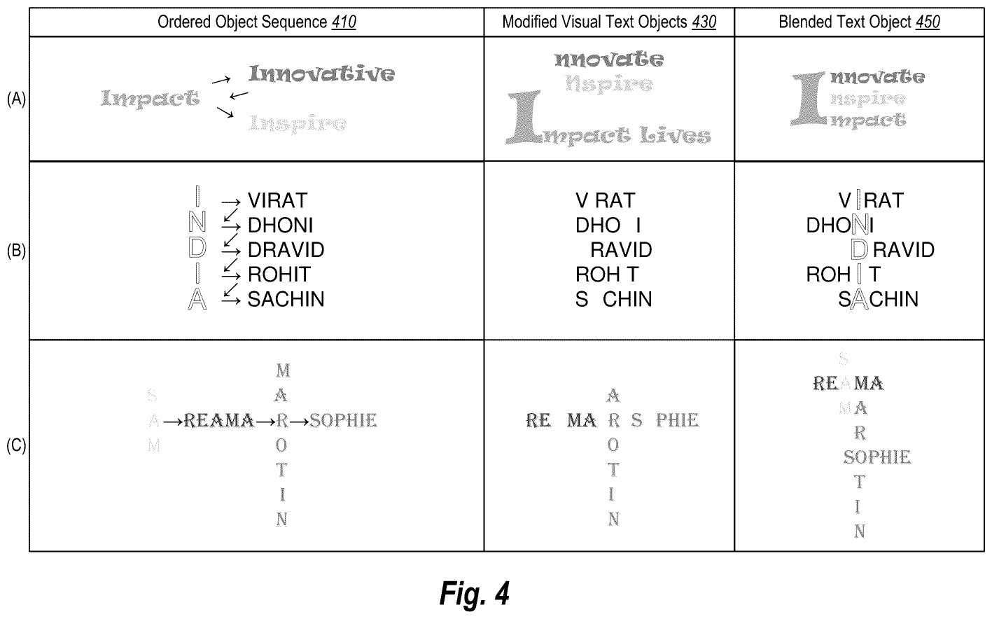

As mentioned, the blended visual object generation system 106 generates modified visual text objects from the visual text objects. FIG. 4 illustrates an example of utilizing an object sequence generation model to generate matched visual text objects in accordance with one or more embodiments.

As shown, the blended visual object generation system 106 utilizes the matched visual text objects to generate an ordered object sequence 410. In particular, after identifying common characters to generate the matched visual text objects, the blended visual object generation system 106 utilizes the object sequence generation model to organize and order pairs of the matched visual text objects such that adjacent pairs of visual text objects in the ordered object sequence 410 share common characters. For example, the object sequence generation model generates the ordered object sequence 410 comprising a plurality of visual text objects from the digital design document ordered such that each adjacent pair of visual text objects in the ordered object sequence have a common character.

In one or more embodiments, the blended visual object generation system 106 utilizes the ordered object sequence 410 to generate a particular type of the blended text object 450. In particular, in some cases, the blended visual object generation system 106 generates the ordered object sequence 410 based on one shared common character between multiple visual text objects (e.g., Section (A)). In some cases, the blended visual object generation system 106 creates the ordered object sequence 410 based on multiple modified visual text objects sharing multiple common characters with a single visual text object (e.g., Section (B)). In some cases, the blended visual object generation system 106 creates the ordered object sequence 410 based on generating a sequence of distinct visual text objects arranged in a specific order (e.g., Section (C)).

To illustrate, the object sequence generation model iteratively analyzes combinations of the matched visual text objects to generate the ordered object sequence. For instance, the object sequence generation model generates the ordered object sequence 410 by generating a first adjacent pair of visual text objects which includes a first visual text object with a first instance of a common character and a second visual text object with a second instance of the common character and a second adjacent pair of visual text objects which includes the second visual text object with a first instance of an additional common character and a third visual text object with a second instance of the additional common character. In one or more embodiments, the object sequence generation model utilizes a “SequenceInfo Algorithm” and/or a “FindSequences Algorithm” to generate the ordered object sequence 410 as follows:

SequenceInfo Algorithm:

| | |
|---|---|
| 1: AI ArtHandleart = 0 | [symbol] Handle to Adobe Illustrator art object |
| 2: std :: stringartString | [symbol] String representation of the art object |
| 3: intprevIndex = −1 | [symbol] Index of the previous matching character in a sequence |
| 4: charprevChar | [symbol] Character that matches with the previous sequence |
| 5: intnextIndex = — | [symbol] Index of the next matching character in a sequence |
| 6: charnextChar | [symbol] Character that matches with the next sequence |
| 7: intmatchCount = 0 | [symbol] Number of matches found in the sequence |
| 8: AIRealfontSize = 0 | [symbol] Font size (overall or average across the sequence) |

FindSequences Algorithm:

```
  InputInput OutputOutput
  artObjectInfo: array of SequenceInfo
  for i ← 0 size of artObjectInfo − 1 do
```

| | |
|---|---|
| if i = 0 then | [symbol] Find next index and char for the first instance |

```
      for j ← 0 size of artObjectInfo[i].artString − 1 do
        for k ← 0 size of artObjectInfo[i + 1].artString − 1 do
          if artObjectInfo[i].artString[j] = artObjectInfo[i + 1].artString[k] then
artObjectInfo[i].nextIndex ← j artObjectInfo[i].nextChar ← artObjectInfo[i +1].artString[k]
artObjectInfo[i].matchCount ← artObjectInfo[i].matchCount + 1
```

break

if artObjectInfo[i].nextIndex ≠ −1 then

| | |
|---|---|
| | break |
| else | [symbol] Find previous index and char for subsequent instances |

```
      for k ← artObjectInfo[i − 1].nextIndex size of artObjectInfo[i − 1].artString − 1 do
        for j ← 0 size of artObjectInfo[i].artString − 1 do
          if artObjectInfo[i].artString[j] = artObjectInfo[i − 1].artString[k] then
artObjectInfo[i].prevIndex ← j artObjectInfo[i].prevChar ← artObjectInfo[i −1].artString[k]
artObjectInfo[i].matchCount ← artObjectInfo[i].matchCount + 1
```

break

if artObjectInfo[i].prevIndex ≠ −1 then

| | |
|---|---|
| break | [symbol] Find next index and char for subsequent instances |

```
        if i < size of artObjectInfo − 1 then
          for j ← artObjectInfo[i].prevIndex size of artObjectInfo[i].artString − 1 do
            for k ← 0 size of artObjectInfo[i + 1].artString − 1 do
```

if artObjectInfo[i].artString[j] = artObjectInfo[i + 1].artString[k]

then artObjectInfo[i].nextIndex ← j artObjectInfo[i].nextChar ← artObjectInfo[i +
1].artString[k] artObjectInfo[i].matchCount ← artObjectInfo[i].matchCount + 1

```
  break
if artObjectInfo[i].nextIndex ≠ −1 then
  break
```

To elaborate, the FindSequences Algorithm initializes by iterating through each SequenceInfo object in the artObjectInfo array. For the first element (e.g., i=0), the FindSequences Algorithm searches for a matching character between artObjectInfo[0] and artObjectInfo[1]. The FindSequences Algorithm updates nextIndex, nextChar, and matchCount if a match is found. For elements beyond the first, the FindSequences Algorithm first finds a match with the previous element (e.g., artObjectInfo[i−1]) to update prevIndex, prevChar, and matchCount. Then, the FindSequences Algorithm searches for a match with the next element (e.g., artObjectInfo[i+1]) to update nextIndex, nextChar, and matchCount. The FindSequences Algorithm includes break conditions in each loop to exit early once a match is found or if no further matches are needed. After completion of the loops, the FindSequences Algorithm includes each updated SequenceInfo object in the artObjectInfo array with fields reflecting its matching relationships with adjacent elements.

For example, the object sequence generation model compares and analyzes a visual text objects (e.g., strings) within an array to organize the visual text objects based on common character matches between each visual text object and the adjacent visual text objects. In this way, the object sequence generation model generates the ordered object sequence 410 in which each element includes include information for a common character shared with the previous visual text object, a common character shared with the subsequent visual text object, and a common character count.

Turning back to the examples in FIG. 4, the object sequence generation model generates an ordered object sequence 410. For example, as shown by the ordered object sequence 410 in Section (A), the object sequence generation model generates the ordered object sequence 410 based on a common character shared between all of the matched visual text objects. As described above in relation to FIG. 3 Section (A), the common character detection model determines a common character of “I” shared between the matched visual text objects. Moreover, based on the common character instances, the object sequence generation model determines an ordered object sequence 410. In some cases, the object sequence generation model determines an ordered object sequence 410 such as shown in FIG. 4 Section (A) wherein the sequence is ordered such as “Impact”→“Innovative”→“Impact”→“Inspire.” In some cases, the object sequence generation model determines an ordered object sequence 410 such that blended visual object generation system 106 determines a single visual text object (e.g., “Impact”) and pairs each of the other visual text objects (e.g., “Innovative” and “Inspire”) with the single visual text object.

In one or more implementations, as shown by the ordered object sequence 410 in Section (B), the object sequence generation model generates the ordered object sequence 410 by associating multiple modified visual text objects with a single visual text object based on multiple common characters. As described above in relation to FIG. 3 Section (B), the common character detection model determines a single visual text object (e.g., “INDIA”) with multiple common character instances shared with multiple visual text objects (e.g., “VIRAT,” “DHONI,” “DRAVID,” “ROHIT,” and “SACHIN”).

Moreover, as shown in FIG. 4 Section (B), based on the multiple common character instances, the object sequence generation model determines an ordered object sequence 410. In some cases, the object sequence generation model determines an ordered object sequence 410 wherein the sequence is ordered such as “INDIA”→“VIRAT”→“INDIA”→“DHONI”→“INDIA”→“DRAVID”→“INDIA”→“ROHIT”→“INDIA”→“SACHIN.” In some cases, the object sequence generation model determines an ordered object sequence 410 such that blended visual object generation system 106 determines a single visual text object (e.g., “INDIA”) and pairs each of the other visual text objects with the single visual text object (e.g., “VIRAT,” “DHONI,” “DRAVID,” “ROHIT,” and “SACHIN”).

In one or more implementations, as shown by the ordered object sequence 410 in Section (C), the object sequence generation model generates the ordered object sequence 410 by ordering multiple modified visual text objects based on multiple common characters such that adjacent pairs of visual text objects in the ordered object sequence share common characters. For example, as described above in relation to FIG. 3 Section (C), the common character detection model determines pairs of visual text objects which share common characters. Based on the pairs of visual text objects, the object sequence generation model determines an ordered object sequence 410. In some cases, the object sequence generation model generates the ordered object sequence 410 such that each visual text object within the ordered object sequence 410 is distinct.

In some cases, the object sequence generation model iteratively analyzes combinations of the matched visual text objects based on the orientations of the matched visual text objects to generate the ordered object sequence 410. For example, the object sequence generation model iteratively analyzes the matched visual text objects based on the orientations of the visual text objects within the matched visual text objects to generate the ordered object sequence 410 by alternating orientations of adjacent visual text objects in Section (C). To illustrate, the object sequence generation model determines an ordered object sequence 410 ordered such as “SAM”→“REAMA”→“MAROTIN”→“SOPHIE.”

As mentioned, in some cases, the blended visual object generation system 106 prioritizes certain character matches (e.g., matched visual text objects) to determine the ordered object sequence 410. For example, the object sequence generation model selects between the matched visual text objects based on a position, size, orientation, or stylistic importance of the common character instances. In some cases, if two of the visual text objects 310 share both “A” and “R,” the blended visual object generation system 106 prioritizes the “A” if the “A” appears to hold more visual weight in the design (e.g., based on position, size, or stylistic importance). In one or more embodiments, the object sequence generation model iteratively analyzes combinations of the matched visual text objects, based on orientations of the matched visual text objects, utilizing the object sequence generation model, to generate the ordered object sequence. To illustrate, in Sections (B) and (C) the object sequence generation model prioritizes matching common characters between the vertical and horizontal visual text objects.

As further illustrated in FIG. 4, the blended visual object generation system 106 generates the modified visual text objects 430 by modifying the visual text objects of the ordered object sequence 410. For example, the blended visual object generation system 106 generates the modified visual text objects 430 by replacing the instances of the common characters with empty character spaces based on the ordered object sequence 410. In one or more embodiments, the blended visual object generation system 106 utilizes an empty character space generated with the same proportions (e.g., size, height, and/or width) as the replaced instance of the common character shared between adjacent visual text objects of the ordered object sequence 410. In some embodiments, the empty character space is generated with the same proportions as the remaining instance of the common character shared between adjacent visual text objects of the ordered object sequence 410.

As illustrated in FIG. 4 in Section (A), in one or more embodiments, the blended visual object generation system 106 generates the modified visual text objects 430 based on a single common character shared between all of the matched visual text objects. In some cases, the blended visual object generation system 106 enlarges one instance of the common character (within “Impact”) and replaces the remaining instances of the common character with empty character spaces to generate the modified visual text objects 430 (e.g., “_nnovate” and “_nspire”). In some cases, the blended visual object generation system 106 enlarges all instances of the common character before replacing all but one instance of the common character with empty character spaces to generate the modified visual text objects 430.

Furthermore, in some embodiments, the blended visual object generation system 106 generates the enlarged common character(s) (e.g., one or more modified instances of the common characters) by adjusting the size of the instance(s) of the common character based on a combined size (e.g., height and/or width) of the visual text objects in the ordered object sequence 410. For example, the blended visual object generation system 106 determines a size of a first visual text object, second visual text object, and third visual text object (i.e., without the enlarged common character). The blended visual object generation system 106 then selects a size for the enlarged common character based on the combined size of the first visual text object, second visual text object, and third visual text object. For instance, the blended visual object generation system 106 selects a font size for the enlarged common character that is equal to or greater than the height of the first text object, second text object, and third text object (and any spacing between the text objects).

As illustrated in FIG. 4 in Section (B), in one or more embodiments, the blended visual object generation system 106 generates the modified visual text objects 430 by replacing the instances of the common characters with empty character spaces based on the ordered object sequence 410. For example, the blended visual object generation system 106 generates the modified visual text objects 430 by replacing the second instance of the common characters between pairs of visual text objects of the ordered object sequence 410 with empty character spaces. In some cases, the blended visual object generation system 106 generates the modified visual text objects 430 by replacing the instances of the common characters within the visual text objects in a second orientation (e.g., horizontal) and retaining the instances of the common characters within the visual text objects in a first orientation (e.g., vertical).

As illustrated in FIG. 4 in Section (C), in one or more embodiments, the blended visual object generation system 106 generates the modified visual text objects 430 by replacing the instances of the common characters with empty character spaces based on the ordered object sequence 410. For example, similar to Section (B), the blended visual object generation system 106 generates the modified visual text objects 430 by replacing the second instance of the common characters between pairs of visual text objects of the ordered object sequence 410 with empty character spaces. In some cases, the blended visual object generation system 106 generates the modified visual text objects 430 by alternating visual text objects in replacing instances of the common characters. For instance, the blended visual object generation system 106 can retain a first instance of a first common character in a vertical text object (e.g., for a first text object in a sequence), replace a second character instance of the first common character in a horizontal text object (e.g., for a second text object in a sequence), then replace an additional character instance of a vertical common character in a vertical text object (e.g., for a third text object in the sequence), then replace another character instance of a third common character in a horizontal text object (e.g., for a fourth text object in the sequence), etc.

In one or more embodiments, the blended visual object generation system 106 generates the blended text object 450 by aligning the modified visual text objects 430. For example, the blended visual object generation system 106 generates the blended text object 450 by aligning a modified visual text objects 430 such that the position of the empty character space of the modified visual text objects 430 intersects with the remaining instance of the common character of the adjacent modified visual text object or adjacent visual text object.

To illustrate, as shown in FIG. 4 in Section (A), the blended visual object generation system 106 generates the blended text object 450 by aligning the modified visual text objects 430. For example, the blended visual object generation system 106 aligns a first modified visual text object, a second modified visual text object, and a third modified visual text object within the digital design document based on an intersection of a first instance of a common character (e.g., “I”) within the first visual text object (e.g., “Impact”), the empty character space of a modified visual text object (e.g., “nspire”), and the empty character space of an additional modified visual text object (e.g., “nnovate”). As shown, the blended visual object generation system 106 aligns the first modified visual text object, a second modified visual text object, and a third modified visual text object within the digital design document based on the size of the modified common character (e.g. height and/or width) and the relative size of the modified visual text objects. For example, the blended visual object generation system 106 aligns all of the modified visual text objects 430 such that the height of the blended text object 450 is equivalent to the combined height of the source visual text objects.

As further shown in FIG. 4 Section (B), the blended visual object generation system 106 generates the blended text object 450 by aligning the modified visual text objects 430 with the visual text object “INDIA.” As shown the visual text object “INDIA” has a first orientation and the modified visual text objects “V_RAT,” “DHO_I,” “_RAVID,” “RHO_T,” and “S_CHIN” have a second orientation. The blended visual object generation system 106 aligns the visual text object “INDIA” and the modified visual text object “V_RAT” by aligning the visual text object “INDIA” in the first orientation and the modified visual text object “V_RAT” in the second orientation such that they intersect at the first instance of the common character “I” and the empty character space within the modified visual text object “V_RAT.” Similarly, the blended visual object generation system 106 aligns the visual text object “INDIA” and the modified visual text objects “V_RAT,” “DHO_I,” “_RAVID,” “RHO_T,” and “S_CHIN” by aligning the visual text object “INDIA” in the first orientation and the modified visual text objects “V_RAT,” “DHO_I,” “RAVID,” “RHO_T,” and “S_CHIN” in the second orientation such that they intersect at the first instance of the common characters “N,” “D,” “I,” and “A” and the empty character spaces within the modified visual text objects “V_RAT,” “DHO_I,” “_RAVID,” “RHO_T,” and “S_CHIN.”

As also shown in FIG. 4 Section (C), the blended visual object generation system 106 generates the blended text object 450 by aligning the visual text object “SAM” with the modified visual text objects 430 based on the ordered object sequence 410. As shown the visual text object “SAM” and modified visual text object “_AROTIN” have a first orientation and the modified visual text objects “RE_MA” and “S_PHIE” have a second orientation. The blended visual object generation system 106 aligns the visual text object “SAM” and the modified visual text object “RE_MA” by aligning the visual text object “SAM” in the first orientation and the modified visual text object “RE_MA” in the second orientation such that they intersect at the first instance of the common character “A” and the empty character space within the modified visual text object “RE_MA.” Similarly, the blended visual object generation system 106 aligns the modified visual text object “RE_MA” and the modified visual text object “__AROTIN” based on the common character “M,” the empty character space, the second orientation, and the first orientation. As also shown, the blended visual object generation system 106 aligns the modified visual text object “_AROTIN” and the modified visual text object “S_PHIE” based on the common character “O,” the empty character space, the first orientation, and the second orientation.

As mentioned, the blended visual object generation system 106 retains the text style features from the visual text objects when generating the blended text object 450. As shown in FIG. 4, the blended text object 450 maintains the font style features of each of the visual text objects when aligning each adjacent pair of visual text objects based on instances of the common characters and the empty character spaces such that the visual text objects intersect. Furthermore, the blended visual object generation system 106 aligns the modified visual text objects based on the proportions of the empty character space and/or the proportions of the remaining common character.

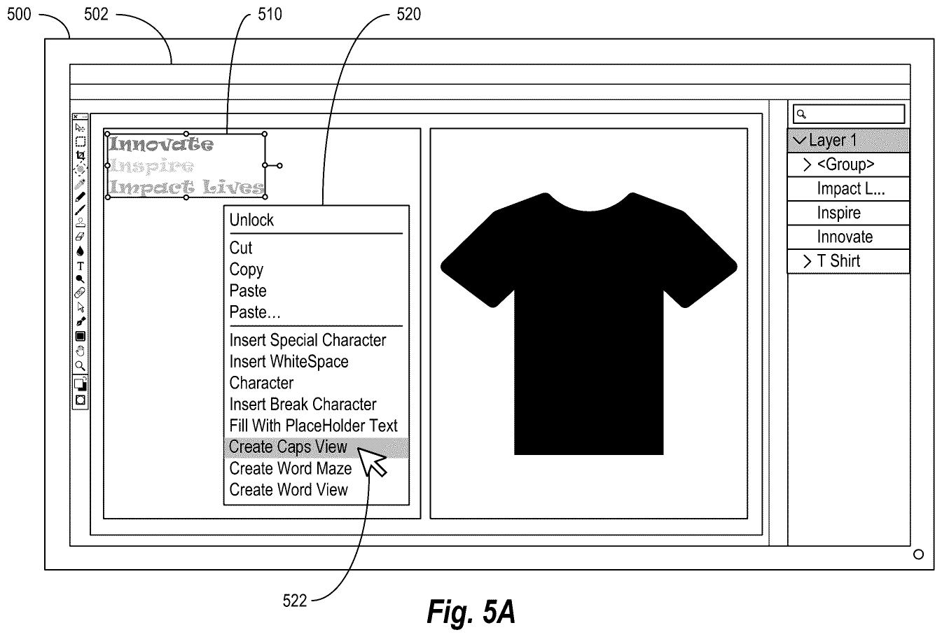

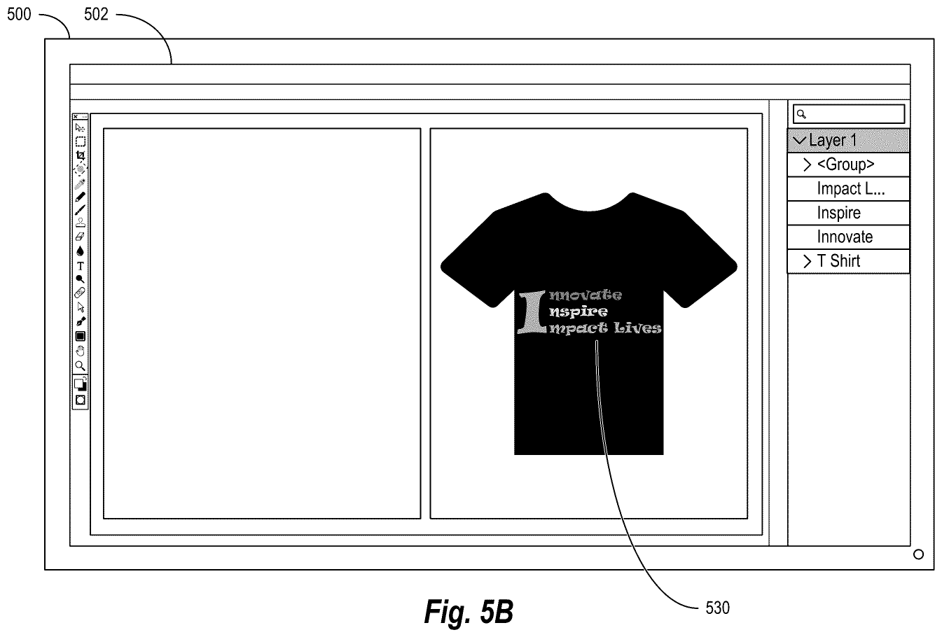

The blended visual object generation system 106 flexibly and efficiently generates the blended text objects as described above in response to a user device interaction with a visual text object blending element of a digital design document. In certain embodiments, the blended visual object generation system 106 utilizes a combination of one or more of the methods described above to generate the blended text objects. FIGS. 5A-7B illustrate various examples of interacting with a visual text object blending element of a user interface to generate a blended text object.

For instance, FIGS. 5A-5B illustrate an example of creating a blended text object that shares one common character between multiple visual text objects by enlarging the common character and aligning the visual text objects with the enlarged character in accordance with one or more embodiments. As shown in FIG. 5A, the blended visual object generation system 106 provides a graphical user interface 502 for display on a client device 500. In particular, the blended visual object generation system 106 provides the graphical user interface 502 for generating a blended text object from visual text objects 510. As shown in FIG. 5A, the blended visual object generation system 106 receives or determines a user device selection of the visual text objects 510. In addition, the blended visual object generation system 106 receives a user device interaction with a visual text object blending element 520 of a user interface selecting an option 522 to “Create Caps View.” In particular, the blended visual object generation system 106 receives a user device interaction requesting the creation of a blended text object based on a shared common character between all of the visual text objects 510.

As shown in FIG. 5B, based on the user selection of the option 522, the blended visual object generation system 106 generates the blended text object 530. In particular, such as described in FIG. 3 Section (A), the common character model determines the 3 common character instances of the letter “I” and generates matched visual text objects based on the common character instances. Furthermore, such as described in FIG. 4 Section (A), the blended visual object generation system 106 generates an ordered object sequence and 3 modified visual text objects of “Impact,” “_nnovate,” and “_nspire.” Furthermore, the blended visual object generation system 106 aligns the 3 modified visual text objects to generate the blended text object 530.

In certain embodiments, the blended visual object generation system 106 provides additional options to generate the blended text object 530. To illustrate, in some embodiments, the blended visual object generation system 106 provides an option to align the visual text objects 510 based on another common character (e.g., a character located in another position of one or more of the visual text objects 510). For example, in some embodiments, the blended visual object generation system 106 provides an option to generate an updated blended text object utilizing a different common character based on a user device interaction. In certain embodiments, the blended visual object generation system 106 provides an option for the user device to receive an input selecting a common character and subsequently aligns the blended text object 530 based on the selected common character.

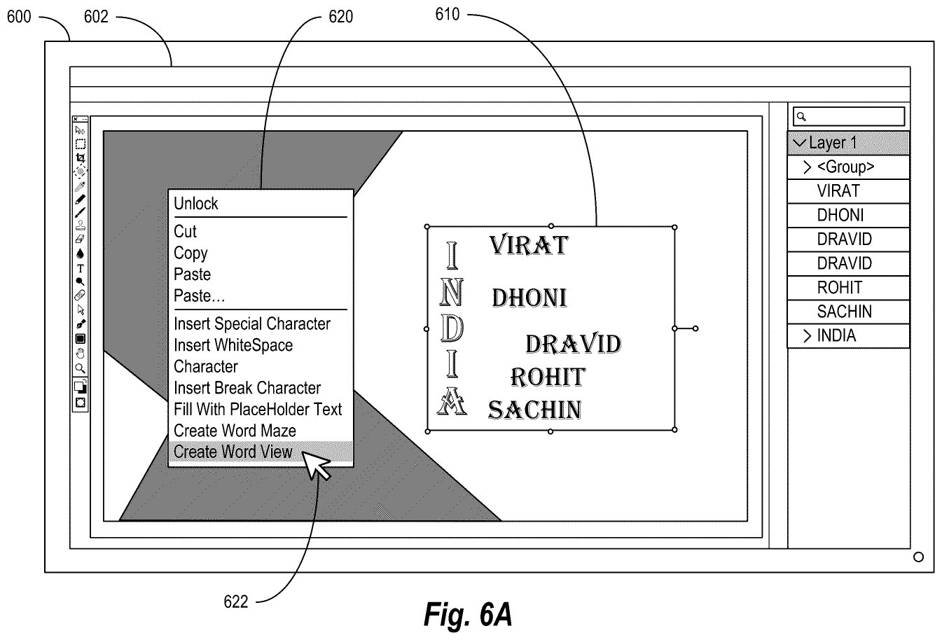

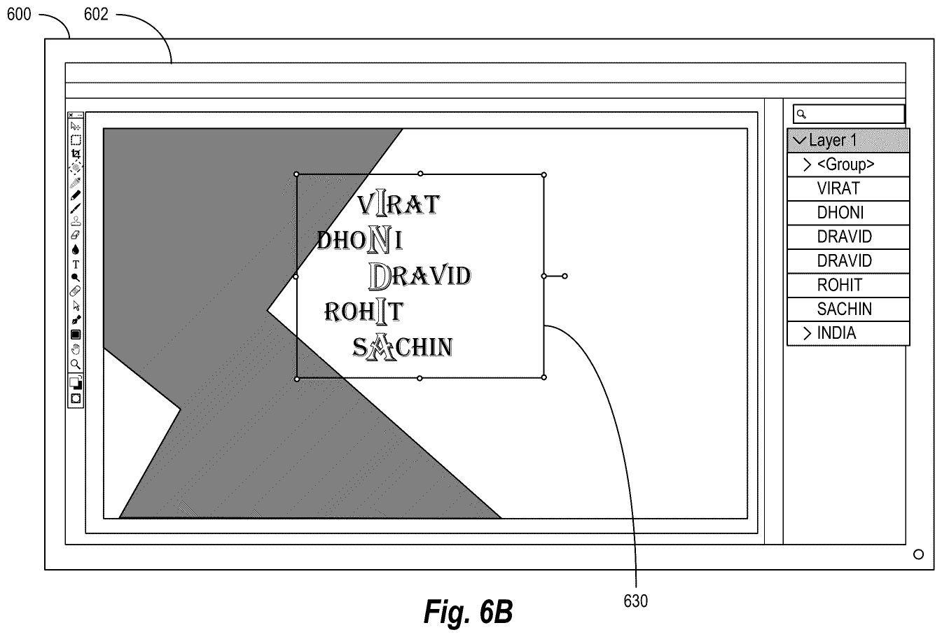

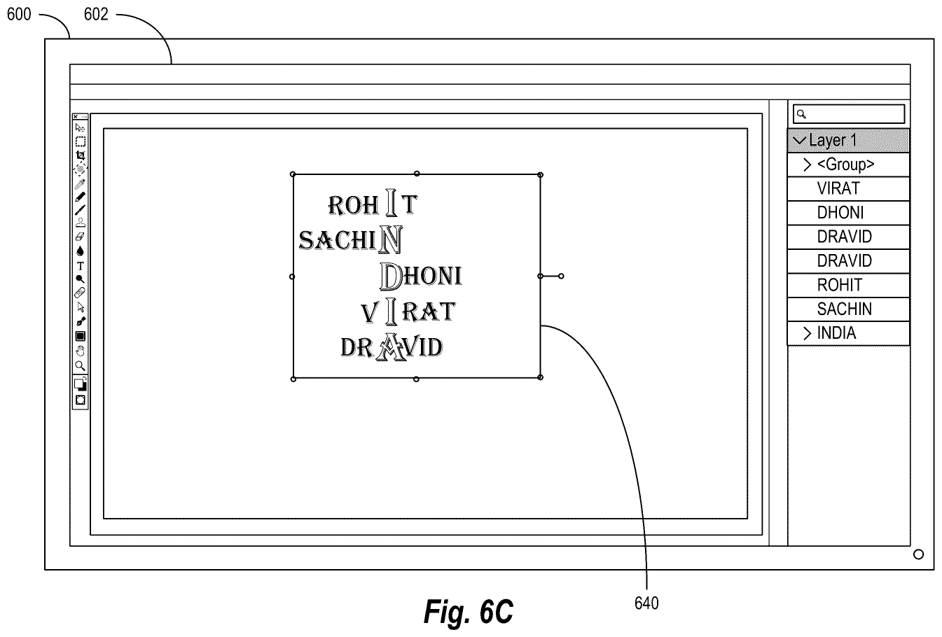

FIGS. 6A-6C illustrate examples of creating a blended text object that aligns multiple visual text objects with a single visual text object based on multiple common characters in accordance with one or more embodiments. As shown in FIG. 6A, the blended visual object generation system 106 provides the graphical user interface 602 for display on a client device 600 for generating a blended text object from visual text objects 610. As shown in FIG. 6A, the blended visual object generation system 106 receives or determines a user device selection of the visual text objects 610. In addition, the blended visual object generation system 106 receives a user device interaction with a visual text object blending element 620 of a user interface selecting an option 622 to “Create Word View.” In particular, the blended visual object generation system 106 receives a user device interaction requesting the creation of a blended text object by aligning multiple modified visual text objects with a single visual text object based on multiple common characters the visual text objects 610.

As shown in FIG. 6B, based on the user selection of the option 622, the blended visual object generation system 106 generates the blended text object 630. In particular, such as described in FIG. 3 Section (B), the common character model determines the common character instances between the horizontal objects of the visual text objects 610 and the characters of the vertical visual text object “INDIA.” Furthermore, such as described in FIG. 4 Section (B), the blended visual object generation system 106 generates an ordered object sequence based on the common character instances of the characters “I,” “N,” “D,” “I,” and “A.” Based on the ordered object sequence, the blended visual object generation system 106 generates modified visual text objects “V_RAT,” “DHO_I,” “_RAVID,” “RHO_T,” and “S_CHIN.” Furthermore, the blended visual object generation system 106 aligns the modified visual text objects with the visual text object “INDIA” to generate the blended text object 630.

Moreover, the blended visual object generation system 106 provides additional options to generate alternate versions of the blended text object 630. For, example, as shown in FIG. 6C and based on a user device interaction with the graphical user interface 602, the blended visual object generation system 106 generates the blended text object 640 utilizing an additional, or alternate, ordered object sequence. To illustrate, in some embodiments, the blended visual object generation system 106 provides an option to align the visual text objects 610 based on other common characters (e.g., a different selection of visual text objects based on the common characters of the visual text objects 610).

To illustrate, the object sequence generation model generates an additional ordered object sequence based on the common character instances of the characters “I,” “N,” “D,” “I,” and “A.” Based on the additional ordered object sequence, the blended visual object generation system 106 generates additional modified visual text objects ROH_T,” “SACHI_,” “_HONI,” “V_RAT,” and “DR_VID.” Furthermore, the blended visual object generation system 106 aligns the additional modified visual text objects with the visual text object “INDIA” to generate the blended text object 640.

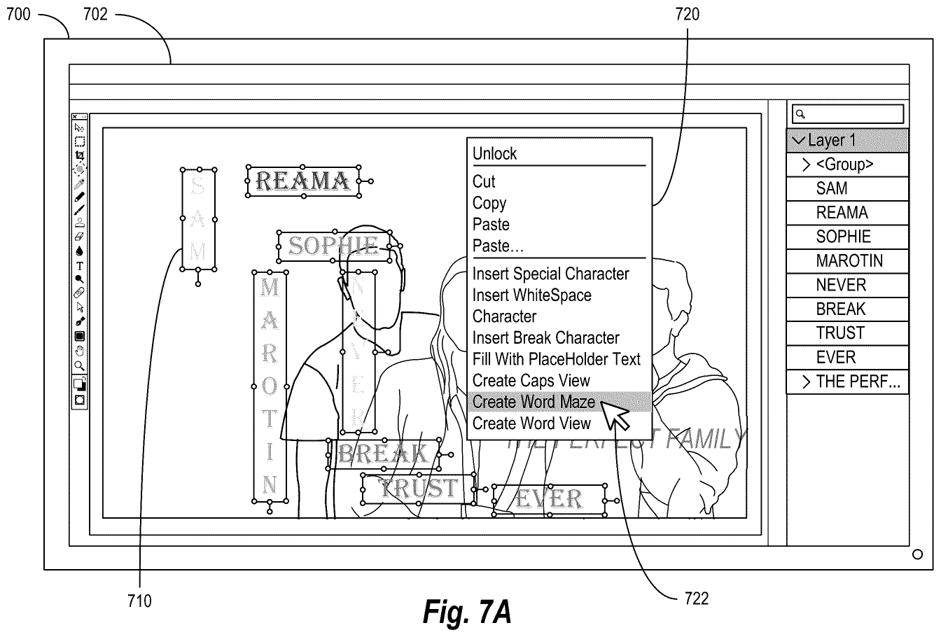

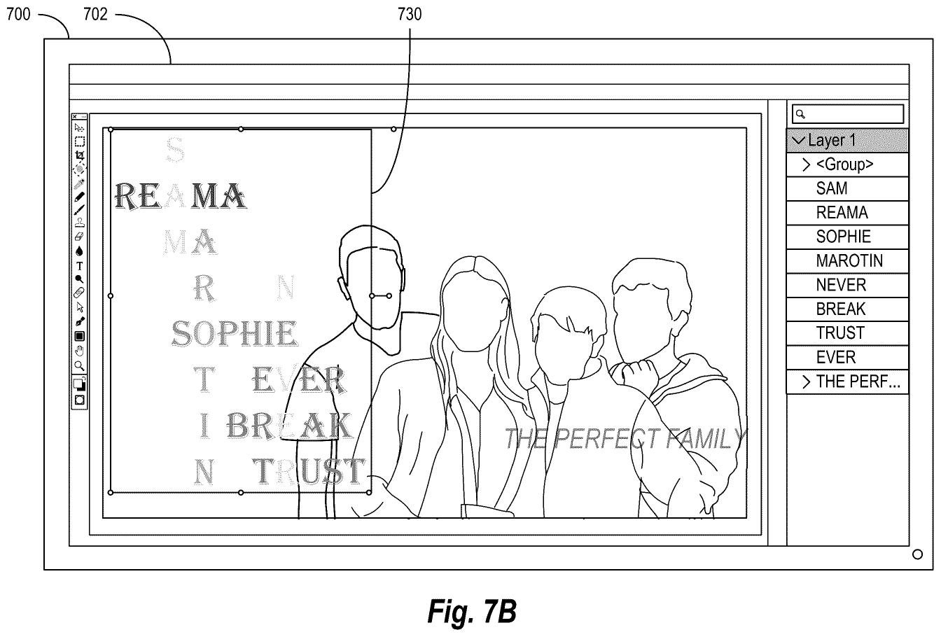

FIGS. 7A-7B illustrate an example of creating a blended text object that aligns multiple visual text objects in a sequence in accordance with one or more embodiments. As shown in FIG. 7A, the blended visual object generation system 106 provides a graphical user interface 702 for display on a client device 700 for generating a blended text object from visual text objects 710. As shown in FIG. 7A, the blended visual object generation system 106 receives or determines a user device selection of the visual text objects 710 (e.g., SAM,” “REAMA,” “MAROTIN,” “SOPHIE,” “NEVER,” “BREAK,” “TRUST,” and “EVER”). In addition, the blended visual object generation system 106 receives a user device interaction with a visual text object blending element 720 of a user interface selecting an option 722 to “Create Word Maze.” In particular, the blended visual object generation system 106 receives a user device interaction for the creation of a blended text object by aligning a sequence of matches between each of the visual text objects 710.

As shown in FIG. 7B, based on the user selection of the option 722, the blended visual object generation system 106 generates the blended text object 730. As shown, in one or more embodiments, the blended visual object generation system 106 generates the blended text object 730 as described in relation to FIGS. 3-4 Sections (B)-(C). To illustrate, the blended visual object generation system 106 generates a portion of the blended text object 730 by selecting common characters utilizing the common character detection model such as described in relation to FIG. 3 Section (C) (e.g., “SAM,” “REAMA,” “MAROTIN,” “SOPHIE,” and “Never”) and a portion of the blended text object 730 by selecting common characters utilizing the common character detection model such as described in relation to FIG. 3 Section (B) (e.g., “N_VER”←→“EVER,” “BREAK,” and “TRUST”).

In particular, such as described in FIG. 3 Sections (C), the common character model determines the common character instances between alternating horizontal objects of the visual text objects 710 and vertical objects of the visual text objects 710 (e.g., “SAM,” “REAMA,” “MAROTIN,” “SOPHIE,” and “NEVER”). Furthermore, such as described in FIG. 4 Section (C), the object sequence generation model generates an ordered object sequence such that each visual text object within the ordered object sequence is distinct. Based on the ordered object sequence, the blended visual object generation system 106 generates modified visual text objects RE_MA,” “_AROTIN,” “S_PHIE,” and “N_VER.” Furthermore, the blended visual object generation system 106 aligns the modified visual text objects based on the ordered object sequence to generate a portion of the blended text object 730.

Furthermore, such as described in FIG. 3 Sections (B), the common character model determines the common character instances between the horizontal objects of the visual text objects 710 (e.g., “EVER,” “BREAK,” “TRUST”) and the characters of the vertical modified visual text object “N_VER.” Furthermore, such as described in FIG. 4 Section (B), the object sequence generation model generates an ordered object sequence based on the common character instances of the characters “V,” “E,” and “R.” Based on the ordered object sequence, the blended visual object generation system 106 generates modified visual text objects “E_ER,” “BR_AK,” and “T_UST.” As shown, the blended visual object generation system 106 aligns the modified visual text objects with the modified visual text object “N_VER” to generate a portion of the blended text object 730.

As also illustrated in FIG. 7B, in certain embodiments, the blended visual object generation system 106 provides tools to transform the blended text object 730 (or any blended text object described herein) with respect to the visual text objects 710. As shown, based on a user device interaction, the blended visual object generation system 106 scales the blended text object 730 (e.g., to be larger in size than the visual text objects 710). In one or more embodiments, the blended visual object generation system 106 transforms the blended text object as follows:

$$Given a point p = ( \frac{x}{y} ) and a transformation matrix T = ( \begin{matrix}a & b \\ c & d\end{matrix} )$$

The transformed point p′ is obtained by multiplying the matrix T by the vector p:

$${p}^{′} = Tp = ( \begin{matrix}a & b \\ c & d\end{matrix} ) ( \frac{x}{y} ) = ( \begin{matrix}ax & by \\ cx & dy\end{matrix} )$$

In particular, the blended visual object generation system 106 transforms the blended text object 730 to modify the proportions of the blended text object 730 utilizing a matched index.

Moreover, in certain embodiments, the blended visual object generation system 106 provides additional options to generate the blended text object 730. For example, the blended visual object generation system 106 provides an option to regenerate the blended text object 730 and align the visual text objects 710 based on an alternate selection of common character instances. In certain embodiments, the blended visual object generation system 106 generates the blended text object 730 such as described in FIG. 3 Section (C) and 4 Section (C). In such cases, the blended visual object generation system 106 generates the entire alignment for the blended text object 730 in the same manner (instead of generating a portion such as described in a combination of FIG. 3 Section (B) and 4 Section (B)).

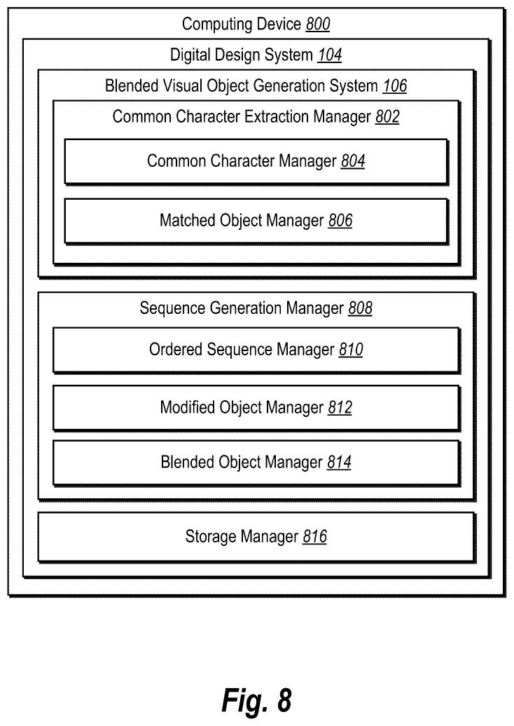

Turning now to FIG. 8, additional detail will now be provided regarding various components and capabilities of the blended visual object generation system 106. In particular, FIG. 8 illustrates the blended visual object generation system 106 implemented by the computing device 800 (e.g., the server device(s) 102 and/or one of the client device(s) 108 discussed above with reference to FIG. 1). Additionally, the blended visual object generation system 106 is also part of the digital design system 104. As shown in FIG. 8, the blended visual object generation system 106 includes, but is not limited to, a common character extraction manager 802, a common character manager 804, a matched object manager 806, a sequence generation manager 808, an ordered sequence manager 810, a modified object manager 812, a blended object manager 814, and a storage manager 816.

As just mentioned, and as illustrated in FIG. 8, the blended visual object generation system 106 includes the common character extraction manager 802. In one or more embodiments, the common character extraction manager 802 manages the extraction of common characters from visual text objects and generates of matched visual text objects from visual text objects. In particular, the common character manager 804 utilizes common character manager 804 and the matched object manager 806 to determine matched visual text objects based on common character instances between the visual text objects. The common character extraction manager 802 includes or refers to a model designed to analyze visual text objects by identifying common characters shared between the visual text objects. In some cases, the common character extraction manager utilizes instances of the common characters to determine matched visual text objects.

In some cases, the sequence generation manager 808 utilizes the common character manager 804 to determine common character instances of the common characters shared between the visual text objects. For example, the common character model analyzes the textual content within each of the visual text objects to identify common character instances by extracting the textual content (e.g., characters) from the visual text objects. In some cases, once the characters are extracted, the common character model compares characters across the visual text objects 310 to identify where the same characters (i.e., common characters) appear within the visual text objects.

Furthermore, in some cases, the sequence generation manager 808 utilizes the matched object manager 806 to determine matched visual text objects based on the common character instances. For example, the common character model determines matches between the visual text objects based on the common character instances. To illustrate, based on two or more of the visual text objects containing instances of the same character, the matched object manager 806 determines the matched visual text objects. In some embodiments, the matched object manager 806 identifies more than one common character between the visual text objects. In some embodiments, the matched object manager 806 identifies specific common characters between the visual text objects (e.g., the initial character or a selected character).

As further shown in FIG. 8, the blended visual object generation system 106 includes the sequence generation manager 808. In particular, the blended visual object generation system 106 utilizes the sequence generation manager 808 to generate modified visual text objects by replacing instances of common characters within the visual text objects with empty character spaces. In particular, the sequence generation manager 808 utilizes the ordered sequence manager 810, the modified object manager 812, and the blended object manager 814 to generate blended text objects based on the common character instances. For example, the sequence generation manager 808 analyzes the matched visual text objects to generate an ordered object sequence organizing the visual text objects based on the common character instances. In some embodiments, the sequence generation manager 808 replaces an instance of each common character in the adjacent pairs of the ordered object sequence with an empty character space. In some cases, the sequence generation manager 808 generates a blended text object by aligning the modified visual text objects based on instances of the common characters and the empty character spaces.

As mentioned, in some cases, the sequence generation manager 808 utilizes the ordered sequence manager 810 to generate ordered object sequences. For example, the ordered sequence manager 810 generates ordered object sequences wherein each adjacent pair of visual text objects within the ordered object sequence share a common character. In some embodiments, the ordered sequence manager 810 utilizes the ordered object sequence to generate a particular type of the blended text object. In some cases, the ordered sequence manager 810 generates the ordered object sequence based on one shared common character between multiple visual text objects. In some cases, the ordered sequence manager 810 creates the ordered object sequence based on multiple modified visual text objects sharing multiple common characters with a single visual text object. In some cases, the ordered sequence manager 810 creates the ordered object sequence based on generating a sequence of distinct visual text objects arranged in a specific order.

Additionally, in some cases, the sequence generation manager 808 utilizes the modified object manager 812 to modify the visual text objects of the ordered object sequence. For example, the modified object manager 812 generates the modified visual text objects by replacing the instances of the common characters with empty character spaces based on the ordered object sequence. For example, an empty character space includes or refers to a placeholder, allowing the blended visual object generation system 106 to position the visual text objects such that the visual text objects intersect at the correct points. In one or more embodiments, the modified object manager 812 utilizes an empty character space generated with the same proportions (e.g., size, height, and/or width) as an instance of the common character shared between adjacent visual text objects of the ordered object sequence.

Additionally, in some cases, the sequence generation manager 808 utilizes the blended object manager 814 to align the modified visual text objects and generate a blended text object. For example, the blended visual object generation system 106 generates the blended text object by aligning a modified visual text objects such that the position of the empty character spaces of the modified visual text objects intersects with the remaining instances of the common characters of the adjacent modified visual text objects or adjacent visual text object. The blended object manager 814 retains the text style features from the visual text objects when generating the blended text object.

Additionally, as shown, the blended visual object generation system 106 includes the storage manager 816. In particular, the storage manager 816 (implemented by one or more memory devices) stores the digital design documents, including the visual text objects and the blended text objects. The storage manager 816 facilitates the use of the digital design documents by the blended visual object generation system 106.

Each of the components 802-814 of the blended visual object generation system 106 includes software, hardware, or both. For example, the components 802-814 include one or more instructions stored on a computer-readable storage medium and executable by processors of one or more computing devices, such as a client device or server device. When executed by the one or more processors, the computer-executable instructions of the blended visual object generation system 106 causes the computing device(s) to perform the methods described herein. Alternatively, the components 802-814 include hardware, such as a special-purpose processing device to perform a certain function or group of functions. Alternatively, the components 802-814 of the blended visual object generation system 106 include a combination of computer-executable instructions and hardware.

Furthermore, the components 802-814 of the blended visual object generation system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 802-814 of the blended visual object generation system 106 are implemented as a stand-alone application, such as a desktop or mobile application. Furthermore, in some embodiments, the components 802-814 of the blended visual object generation system 106 are implemented as one or more web-based applications hosted on a remote server. Alternatively, or additionally, the components 802-814 of the blended visual object generation system 106 are implemented in a suite of mobile device applications or “apps.” For example, in one or more embodiments, the blended visual object generation system 106 comprises or operates in connection with digital software applications such as: ADOBE® PHOTOSHOP®, ADOBE® PHOTOSHOP® ELEMENTS, ADOBE® ILLUSTRATOR®, ADOBE® INCOPY, ADOBE® INDESIGN®, and ADOBE® DESIGNER, ADOBE® CC WEB. The foregoing are either registered trademarks or trademarks of Adobe Inc. in the United States and/or other countries.

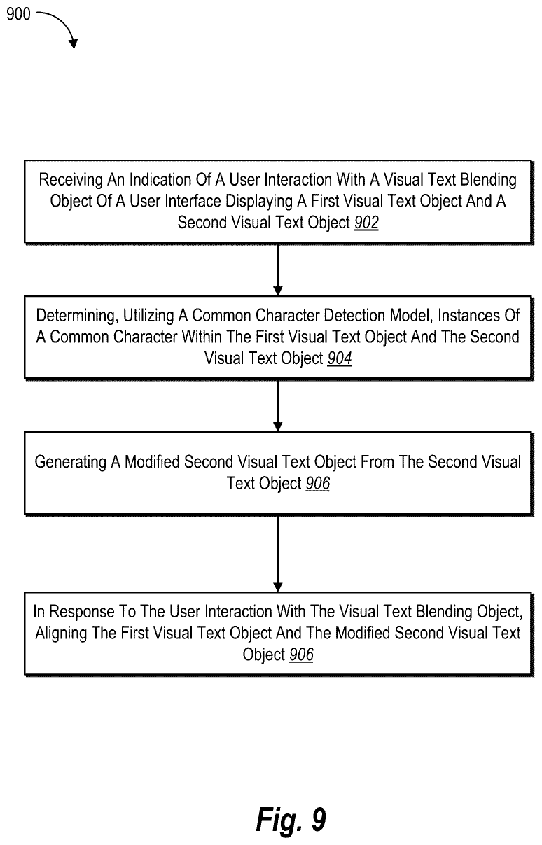

FIGS. 1-8, the corresponding text, and the examples provide a number of different methods, systems, devices, and non-transitory computer-readable media of the blended visual object generation system 106. In addition to the foregoing, one or more embodiments are also described in terms of flowcharts comprising acts for accomplishing a particular result, as shown in FIG. 9. In some embodiments, the acts shown in FIG. 9 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 9. In some embodiments, a system is configured to perform the acts of FIG. 9. Alternatively, the acts of FIG. 9 are performed as part of a computer-implemented method.

FIG. 9 illustrates a flowchart of a series of acts 900 for modifying a digital document with a blended visual object generation system 106 in accordance with one or more embodiments. While FIG. 9 illustrates acts according to one embodiment, alternative embodiments omit, add to, reorder, and/or modify any acts shown in FIG. 9.

FIG. 9 illustrates an example series of acts 900 for utilizing a blended visual object generation system 106 to generate a blended text object from visual text objects within a digital design document. In particular, in certain embodiments, the series of acts 900 includes an act 902 of receiving an indication of a user interaction with a visual text blending object of a user interface displaying a first visual text object and a second visual text object. Specifically, in one or more embodiments, the act 902 includes receiving an indication of a user interaction with a visual text object blending element of a user interface of a client device, wherein the user interface displays a digital design document having a first visual text object and a second visual text object. In one or more embodiments, the series of acts 900 includes an act 904 of determining, utilizing a common character detection model, instances of a common character within the first visual text object and the second visual text object. Specifically, in one or more embodiments, the act 904 includes determining, utilizing a common character detection model, a first instance of a common character within the first visual text object and a second instance of the common character within the second visual text object. In particular, in certain embodiments, the series of acts 900 includes an act 906 of generating a modified second visual text object from the second visual text object. In particular, in one or more embodiments, the act 904 includes generating a modified second visual text object by replacing the second instance of the common character within the second visual text object with an empty character space. As illustrated, in some embodiments, the series of acts 900 also includes an act 908 of, in response to the user interaction with the visual text blending object, aligning the first visual text object and the modified second visual text object. In particular, in one or more embodiments, the act 908 includes, in response to the user interaction with the visual text object blending element, generate a blended text object by aligning the first visual text object and the modified second visual text object within the digital design document based on the first instance of the common character and the empty character space.

In addition (or in the alternative) to the acts described above, in certain embodiments, the blended visual object generation system series of acts 900 includes generating a modified first instance of the common character by adjusting a size of the first instance of the common character based on a combined height of the first visual text object and the second visual text object. In some embodiments, the series of acts 900 also includes aligning the modified second visual text object to the modified first instance of the common character within the digital design document.

Moreover, in one or more embodiments, the blended visual object generation system 106 series of acts 900 includes determining, utilizing the common character detection model, a third instance of the common character within a third visual text object. Further still, in some embodiments, the blended visual object generation system 106 series of acts 900 includes generating a modified third visual text object by replacing the third instance of the common character within the third visual text object with an additional empty character space. Furthermore, in one or more embodiments, the blended visual object generation system series of acts 900 includes aligning the modified third visual text object within the digital design document based on the first instance of the common character and the additional empty character space.

Moreover, one or more embodiments, the series of acts 900 includes determining first text style features associated with the first visual text object and second text style features associated with the second visual text object. Further still, in one or more embodiments, the series of acts 900 includes aligning the first visual text object and the second visual text object while maintaining the first text style features of the first visual text object and maintaining the second text style features of the second visual text object. Moreover, in one or more embodiments, the series of acts 900 includes generating the blended text object by aligning the first visual text object and a third visual text object within the digital design document based on an intersection of a first instance of an additional common character within the first visual text object and an additional empty space replacing a second instance of the additional common character within the third visual text object.

In certain embodiments, the series of acts 900 further includes an act wherein the first visual text object has a first orientation and the second visual text object has a second orientation and aligning the first visual text object and the modified second visual text object within the digital design document comprises aligning the first visual text object in the first orientation and the modified second visual text object in the second orientation such that first visual text object and the modified second visual text object intersect at the first instance of the common character and the empty character space. Moreover, one or more embodiments, the series of acts 900 includes generating, utilizing an object sequence generation model, an ordered object sequence comprising a plurality of visual text objects from the digital design document including the first visual text object and the second visual text object, ordered such that each adjacent pair of visual text objects in the ordered object sequence have a shared character.

Furthermore, in one or more embodiments, the series of acts 900 includes replacing, for each adjacent pair of visual text objects in the ordered object sequence, a second instance of the shared character with a character space. Moreover, in one or more embodiments, the series of acts 900 includes aligning the plurality of visual text objects within the digital design document by, for each adjacent pair of visual text objects in the ordered object sequence, aligning each adjacent pair of visual text objects based on a first instance of the shared character and the character space.

In one or more embodiments, the series of acts 900 includes extracting a plurality of visual text objects from a digital design document, the plurality of visual text objects comprising a plurality of text style features. Further still, in one or more embodiments, the series of acts 900 includes generating, utilizing an object sequence generation model, an ordered object sequence comprising the plurality of visual text objects ordered such that adjacent pairs of visual text objects in the ordered object sequence share common characters. In one or more embodiments, the series of acts 900 further includes generating, utilizing the ordered object sequence, a blended text object by replacing instances of the common characters shared in the adjacent pairs of visual text objects in the ordered object sequence with empty character spaces and aligning the adjacent pairs from the ordered object sequence based on the empty character spaces such that the plurality of visual text objects intersect and maintain the plurality of text style features.

In addition, in one or more embodiments, the series of acts 900 includes extracting the plurality of visual text objects comprises extracting a set of text style features associated with a first visual text object of the plurality of visual text objects, wherein the set of text style features comprise a text color and a text size. Furthermore, in one or more embodiments, the series of acts 900 includes aligning the adjacent pairs comprises aligning the first visual text object and a second visual text object while maintaining the text color and the text size of the first visual text object. In addition, in one or more embodiments, the series of acts 900 includes determining, utilizing a common character detection model, matched visual text objects sharing common characters. Moreover, in one or more embodiments, the series of acts 900 includes iteratively analyzing combinations of the matched visual text objects, utilizing the object sequence generation model, to generate the ordered object sequence.

In one or more embodiments, the series of acts 900 includes generating the ordered object sequence comprises generating a first adjacent pair of visual text objects comprising a first visual text object having a first instance of a common character and a second visual text object having a second instance of the common character. Furthermore, in one or more embodiments, the series of acts 900 includes replacing the instances of the common characters comprises, generating a modified second visual text object by replacing the second instance of the common character of the second visual text object with an empty character space.

In some embodiments, the series of acts 900 also includes generating a modified first visual text object by modifying a size of the first instance of the common character based on a combined height of the first visual text object and the modified second visual text object. Moreover, in one or more embodiments, the blended visual object generation system 106 series of acts 900 includes aligning the modified first visual text object and the modified second visual text object based on the size of the first instance of the common character. Further still, in some embodiments, the blended visual object generation system 106 series of acts 900 includes extracting a first orientation of the first visual text object and a second orientation of the second visual text object. Furthermore, in one or more embodiments, the blended visual object generation system series of acts 900 includes aligning the first visual text object in the first orientation and the modified second visual text object in the second orientation such that first visual text object and the modified second visual text object intersect at the empty character space and the first instance of the common character.

Moreover, one or more embodiments, the series of acts 900 includes generating the ordered object sequence by generating a second adjacent pair of visual text objects comprising the second visual text object having a first instance of an additional common character and a third visual text object having a second instance of the additional common character. Further still, in one or more embodiments, the series of acts 900 includes aligning the second visual text object and the third visual text object based on the additional common character. Moreover, in one or more embodiments, the series of acts 900 includes generating a modified first instance of the common character by adjusting a size of the first instance of the common character based on a combined height of the first visual text object and the second visual text object. In certain embodiments, the series of acts 900 further includes aligning the modified second visual text object to the modified first instance of the common character within the digital design document based on a relative height of the second visual text object to the modified first instance of the common character.

Moreover, one or more embodiments, the series of acts 900 includes generating a modified third visual text object by replacing a second instance of an additional common character within a third visual text object with an additional empty character space. Furthermore, in one or more embodiments, the series of acts 900 includes aligning the first visual text object and the modified third visual text object within the digital design document based on a first instance of the common character within the first visual text object and the additional empty character space.

Moreover, in one or more embodiments, the series of acts 900 includes generating, utilizing an object sequence generation model, an ordered object sequence comprising the first visual text object and the second visual text object, ordered such that pairs of adjacent visual text objects in the ordered object sequence have a shared character. In one or more embodiments, the series of acts 900 includes extracting a first set of text style features of the first visual text object, the first set of text style features comprising a first font size or a first font color. Further still, in one or more embodiments, the series of acts 900 includes extracting a second set of text style features of the second visual text object, the second set of text style features comprising a second font size or a second font color. Moreover, in one or more embodiments, the series of acts 900 includes aligning the first visual text object and the second visual text object while maintaining the first set of text style features of the first visual text object and maintaining the second set of text style features of the second visual text object.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., server device(s) 102, client device(s) 108, and computing device 1000). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
receiving an indication of a user interaction with a visual text object blending element of a user interface of a client device, wherein the user interface displays a digital design document having a first visual text object and a second visual text object;
determining, utilizing a common character detection model, a first instance of a common character within the first visual text object and a second instance of the common character within the second visual text object;
generating a modified second visual text object by replacing the second instance of the common character within the second visual text object with an empty character space; and
in response to the user interaction with the visual text object blending element, generate a blended text object by aligning the first visual text object and the modified second visual text object within the digital design document based on the first instance of the common character and the empty character space.

2. The method of claim 1, further comprising generating the blended text object by:
generating a modified first instance of the common character by adjusting a size of the first instance of the common character based on a combined height of the first visual text object and the second visual text object; and
aligning the modified second visual text object to the modified first instance of the common character within the digital design document.

3. The method of claim 1, further comprising generating the blended text object by:
determining, utilizing the common character detection model, a third instance of the common character within a third visual text object;
generating a modified third visual text object by replacing the third instance of the common character within the third visual text object with an additional empty character space; and
aligning the modified third visual text object within the digital design document based on the first instance of the common character and the additional empty character space.

4. The method of claim 1, further comprising generating the blended text object by:
determining first text style features associated with the first visual text object and second text style features associated with the second visual text object; and
aligning the first visual text object and the second visual text object while maintaining the first text style features of the first visual text object and maintaining the second text style features of the second visual text object.

5. The method of claim 1, further comprising generating the blended text object by aligning the first visual text object and a third visual text object within the digital design document based on an intersection of a first instance of an additional common character within the first visual text object and an additional empty space replacing a second instance of the additional common character within the third visual text object.

6. The method of claim 1, wherein the first visual text object has a first orientation and the second visual text object has a second orientation and aligning the first visual text object and the modified second visual text object within the digital design document comprises aligning the first visual text object in the first orientation and the modified second visual text object in the second orientation such that first visual text object and the modified second visual text object intersect at the first instance of the common character and the empty character space.

7. The method of claim 1, further comprising generating, utilizing an object sequence generation model, an ordered object sequence comprising a plurality of visual text objects from the digital design document including the first visual text object and the second visual text object, ordered such that each adjacent pair of visual text objects in the ordered object sequence have a shared character.

8. The method of claim 7, further comprising:
replacing, for each adjacent pair of visual text objects in the ordered object sequence, a second instance of the shared character with a character space; and
aligning the plurality of visual text objects within the digital design document by, for each adjacent pair of visual text objects in the ordered object sequence, aligning each adjacent pair of visual text objects based on a second instance of the shared character and the character space.

9. A system comprising:
a memory component; and
one or more processing devices coupled to the memory component, the one or more processing devices to perform operations comprising:
extracting a plurality of visual text objects from a digital design document, the plurality of visual text objects comprising a plurality of text style features;
generating, utilizing an object sequence generation model, an ordered object sequence comprising the plurality of visual text objects ordered such that adjacent pairs of visual text objects in the ordered object sequence share common characters; and
generating, utilizing the ordered object sequence, a blended text object by:
replacing instances of the common characters shared in the adjacent pairs of visual text objects in the ordered object sequence with empty character spaces; and
aligning the adjacent pairs from the ordered object sequence based on the empty character spaces such that the plurality of visual text objects intersect and maintain the plurality of text style features.

10. The system of claim 9, wherein:
extracting the plurality of visual text objects comprises extracting a set of text style features associated with a first visual text object of the plurality of visual text objects, wherein the set of text style features comprise a text color and a text size, and
aligning the adjacent pairs comprises aligning the first visual text object and a second visual text object while maintaining the text color and the text size of the first visual text object.

11. The system of claim 9, wherein generating the ordered object sequence comprises:
determining, utilizing a common character detection model, matched visual text objects sharing common characters; and
iteratively analyzing combinations of the matched visual text objects, utilizing the object sequence generation model, to generate the ordered object sequence.

12. The system of claim 9, wherein:
generating the ordered object sequence comprises generating a first adjacent pair of visual text objects comprising a first visual text object having a first instance of a common character and a second visual text object having a second instance of the common character; and
replacing the instances of the common characters comprises, generating a modified second visual text object by replacing the second instance of the common character of the second visual text object with an empty character space.

13. The system of claim 12, wherein the operations further comprise:
generating a modified first visual text object by modifying a size of the first instance of the common character based on a combined height of the first visual text object and the modified second visual text object; and
aligning the modified first visual text object and the modified second visual text object based on the size of the first instance of the common character.

14. The system of claim 12, wherein the operations further comprise:
extracting a first orientation of the first visual text object and a second orientation of the second visual text object; and
aligning the first visual text object in the first orientation and the modified second visual text object in the second orientation such that first visual text object and the modified second visual text object intersect at the empty character space and the first instance of the common character.

15. The system of claim 14, wherein the operations further comprise:
generating the ordered object sequence by generating a second adjacent pair of visual text objects comprising the second visual text object having a first instance of an additional common character and a third visual text object having a second instance of the additional common character; and
aligning the second visual text object and the third visual text object based on the additional common character.

16. A non-transitory computer readable medium storing executable instructions which, when executed by a processing device, cause the processing device to perform operations comprising:
receiving an indication of a user interaction with a visual text object blending element of a user interface of a client device, wherein the user interface displays a digital design document having a first visual text object and a second visual text object;
determining, utilizing a common character detection model, a first instance of a common character within the first visual text object and a second instance of the common character within the second visual text object;
generating a modified second visual text object by replacing the second instance of the common character within the second visual text object with an empty character space; and
in response to the user interaction with the visual text object blending element, generate a blended text object by aligning the first visual text object and the modified second visual text object within the digital design document based on the first instance of the common character and the empty character space.

17. The non-transitory computer readable medium of claim 16, wherein the operations further comprise:
generating a modified first instance of the common character by adjusting a size of the first instance of the common character based on a combined height of the first visual text object and the second visual text object; and
aligning the modified second visual text object to the modified first instance of the common character within the digital design document based on a relative height of the second visual text object to the modified first instance of the common character.

18. The non-transitory computer readable medium of claim 16, wherein the operations further comprise:
generating a modified third visual text object by replacing a second instance of an additional common character within a third visual text object with an additional empty character space; and
aligning the first visual text object and the modified third visual text object within the digital design document based on a first instance of the common character within the first visual text object and the additional empty character space.

19. The non-transitory computer readable medium of claim 16, wherein the operations further comprise:
generating, utilizing an object sequence generation model, an ordered object sequence comprising the first visual text object and the second visual text object, ordered such that pairs of adjacent visual text objects in the ordered object sequence have a shared character.

20. The non-transitory computer readable medium of claim 16, wherein the operations further comprise:
extracting a first set of text style features of the first visual text object, the first set of text style features comprising a first font size or a first font color;
extracting a second set of text style features of the second visual text object, the second set of text style features comprising a second font size or a second font color; and
aligning the first visual text object and the second visual text object while maintaining the first set of text style features of the first visual text object and maintaining the second set of text style features of the second visual text object.
